(19) United States
(12) Patent Application Publication
(10) Pub. No.: US 2014/0241731 A1
(43) Pub. Date: Aug. 28, 2014

(54) SYSTEM AND METHOD FOR FREE SPACE OPTICAL COMMUNICATION BEAM ACQUISITION

(71) Applicant: HARRIS CORPORATION, Melbourne, FL (US)

(72) Inventors: Robert C. Peach, Rockledge, FL (US); Geoffrey L. Burdge, St. Petersburg, FL (US); Terry Tidwell, West Fork, AR (US); John Grady Vickers, Fayetteville, AR (US)

(73) Assignee: HARRIS CORPORATION, Melbourne, FL (US)

(21) Appl. No.: 13/780,489

(22) Filed: Feb. 28, 2013

(51) Int. Cl. H04B 10/11

(52) U.S. Cl. CPC H04B 10/11
USPC 398/128; 398/139

(57) ABSTRACT

A free space optical communication system (10) including first and second mono-static transceivers (20a, 20b). Each transceiver (20a, 20b) includes a reflective assembly (40) defining a reflective surface (44) about a receiving end of a respective optical fiber (32) and configured to reflect optical signals (26) within a field of view of the transceiver (20a, 20b) as a modulated retro-reflective signal (28). Each mono-static transceiver (20a, 20b) includes an acquisition system (60) configured to detect a modulated retro-reflective signal (28) and adjust the alignment of the respective transceiver (20a, 20b) in response to a detected modulated retro-reflective signal (28). A mono-static transceiver and a method of aligning a mono-static transceiver are also provided.

### FIELD OF THE INVENTION

The present invention relates to the field of optical communications, and in particular to the field of beam steering for mono-static bidirectional free space optical transceivers. More particularly, the present invention relates to a beam pointing and tracking system and method utilizing pulsed beams to assist in target acquisition.

### BACKGROUND OF THE INVENTION

Optical communications systems are today employed in a vast array of applications, including without limitation communication with aircraft and satellites from ground positions. A unidirectional optical communications system generally consists of a transmitting terminal and a receiving terminal while a bidirectional system includes a pair of transceivers, each of which acts as both a transmitting terminal and a receiving terminal. In either system, a transmitting terminal typically receives an electrical signal from a signal source, converts the electrical signal into an optical signal and then transmits the resulting optical signal using a transmitting telescope. The receiving terminal receives the optical signal through a receiving telescope, which focuses the optical signal into an optical photodetector, and then converts the optical signal back into an electrical signal.

In a mono-static system, both the receiving terminal and the transmitting terminal utilize the aperture of a single telescope. An optical circulator or other bulk optical techniques are utilized to separate the transmit and receive paths such that the beams traveling in opposite directions occupy the same telescope.

Accurate alignment of the transceiver system is essential for free space optical communications systems. In order for a receiving terminal to receive an optical signal from a corresponding transmitting terminal, the telescopes must be properly aligned. This alignment process is known as beam steering. In a bidirectional optical system, beam steering is the manipulation of one or both of the transceivers to point in a desired direction. Beam steering in optical systems may also be accomplished by various systems, for example, a motorized gimballing system, acousto-optics, liquid crystals, electro-optics, micro-optics, a galvanometer, magnetic mirrors, micro-mirror arrays, and micro-electro-mechanical systems.

In order for an optical receiver to begin receiving a signal from a transmitter, the incoming search signal must first be located and the receiver pointed in the direction of the incoming signal. In a bidirectional system, the receiver terminal of each transceiver must be aligned with the transmitting terminal of the other transceiver. During the initial search for a signal, or if the signal is lost for some reason and reacquisition is thus necessary, a search pattern is generated by an algorithm stored in the control system. The initial search utilizes macro adjustment to locate the field of view (FOV) of the opposite transceiver, and once it is recognized that the FOV has been found, micro adjustment is utilized to align the signal precisely with the optical fiber of the receiving terminal.

To more efficiently recognize when the FOV has been found and to expedite the micro adjustment, systems have been developed with a mirror or other reflective surface about the optical fiber. When the transmitted signal is within the FOV of the other transceiver, the signal is retro-reflected off the mirror along the same path back to the transmitting transceiver. Upon receipt of a retro-reflected signal, the transmitting transceiver assumes that it is aligned within the FOV and micro adjustment is implemented to achieve precise alignment. This procedure is simultaneously performed for both transceivers. (See for example U.S. Pat. No. 8,160,452 which is incorporated herein by reference).

As the use of free space optical communication continues to increase, it has become desirable to use such communication systems over larger and larger distances, for example, over 10 kilometers or more. To align such long distance systems, it is necessary for the retro-reflective signal to be received and recognized by the transmitting transceiver. Since the signal is traveling from the transmitting transceiver to the receiving transceiver and then reflected back to the transmitting transceiver, the signal experiences two-way path loss. As the distance increases, there is risk that the two-way path loss will cause the signal strength to fall below the noise floor caused by other optical sources, reflections or glints. Furthermore, in a mono-static system, there is limited isolation within the optical circulator or bulk optical beam splitter. If the signal strength of the retro-reflective signal is less than the isolation, the system will not be able to differentiate between the transmitted and reflected signals

It is desirable to provide a system and a method wherein the retro-reflective signals are reliably received and recognized by the transmitting terminals.

### SUMMARY OF THE INVENTION

Briefly, the present invention provides a free space optical communication system. The system includes a first and second mono-static transceivers configured to transmit and receive optical signals through an optical fiber. The first mono-static transceiver includes a first reflective assembly defining a first reflective surface about a receiving end of the first optical fiber and configured to reflect optical signals within a field of view of the first transceiver but not aligned with the receiving end of the first optical fiber as a modulated retro-reflective signal. The second mono-static transceiver includes a second reflective assembly defining a second reflective surface about a receiving end of the second optical fiber and configured to reflect optical signals within a field of view of the second transceiver but not aligned with the receiving end of the second optical fiber as a modulated retro-reflective signal. Each mono-static transceiver includes an acquisition system configured to detect a modulated retro-reflective signal and adjust the alignment of the respective transceiver in response to a detected modulated retro-reflective signal.

In one aspect, the invention provides a mono-static transceiver configured to transmit and receive signals through an optical fiber. The transceiver includes an adjustable telescope through which optical signals are transmitting and received. An acquisition system of the transceiver is configured to detect a modulated signal and adjust the alignment of the telescope in response to a detected modulated signal.

In another aspect, the invention provides a method of aligning a first mono-static transceiver with an optical fiber of a second mono-static transceiver. The method includes transmitting an optical signal from a telescope of the first transceiver; adjusting the alignment of the telescope of the first transceiver until the optical signal is within the field of view of the second transceiver whereby the signal is retro-reflected as a modulated signal if the signal is not aligned with the optical fiber; receiving the modulated signal through the telescope of the first transceiver; detecting the modulated signal with an acquisition system of the first transceiver; and further adjusting the alignment of the telescope in response to the detected modulated signal.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a schematic view illustrating an exemplary free space optical communication system in accordance with an embodiment of the invention.

FIG. 2 is a schematic view illustrating exemplary beam paths through one of the transceivers of FIG. 1.

FIG. 3 is a schematic block diagram of an exemplary transceiver of the free space optical communication system of FIG. 1.

FIG. 4 is a perspective view of an exemplary mirror in accordance with an embodiment of the invention.

FIG. 5 is a partial perspective view of another exemplary mirror in accordance with an embodiment of the invention.

FIG. 6 is a side elevation view of the mirror of FIG. 5.

FIG. 7 is a side elevation view of another exemplary mirror in accordance with an embodiment of the invention.

FIG. 8 is a perspective view of an exemplary mirror assembly in accordance with an embodiment of the invention with the mirror assembly in a transmit state.

FIG. 9 is a perspective view of the exemplary mirror assembly of FIG. 8 with the mirror assembly in a non-transmit state.

FIG. 10 is a schematic view illustrating an illustrative path of a transmit signal through an exemplary transceiver.

FIG. 11 is a schematic view similar to FIG. 10 and illustrating the path of the corresponding retro-reflective signal.

FIG. 12 is a schematic block diagram of an alternative exemplary transceiver.

FIG. 13 is a schematic view illustrating the transmit signal received through the transceiver of FIG. 12.

FIG. 14 is a schematic view similar to FIG. 13 and illustrating the path of the corresponding retro-reflective signal.

FIGS. 15A-15D are schematic views illustrating an alignment sequence of the exemplary free space optical communication system of FIG. 1.

### DETAILED DESCRIPTION OF THE INVENTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein.

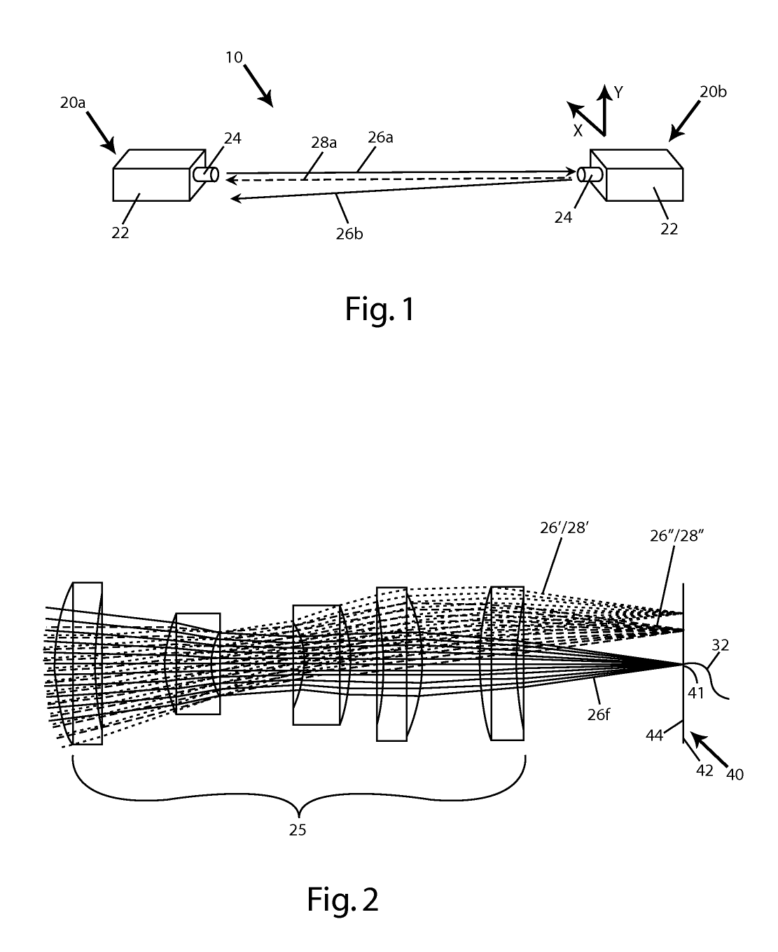

Referring to FIGS. 1-3, the exemplary free space optical communication system 10 includes a pair of mono-static transceivers 20a and 20b. Each transceiver 20a and 20b includes a single telescope 24 extending from a housing 22. The system 10 may be configured such that one or both housings 22 are adjustable in the X and Y planes, or one or both housings 22 may be fixed and the internal components adjustable in the X and Y planes to align the telescopes 24.

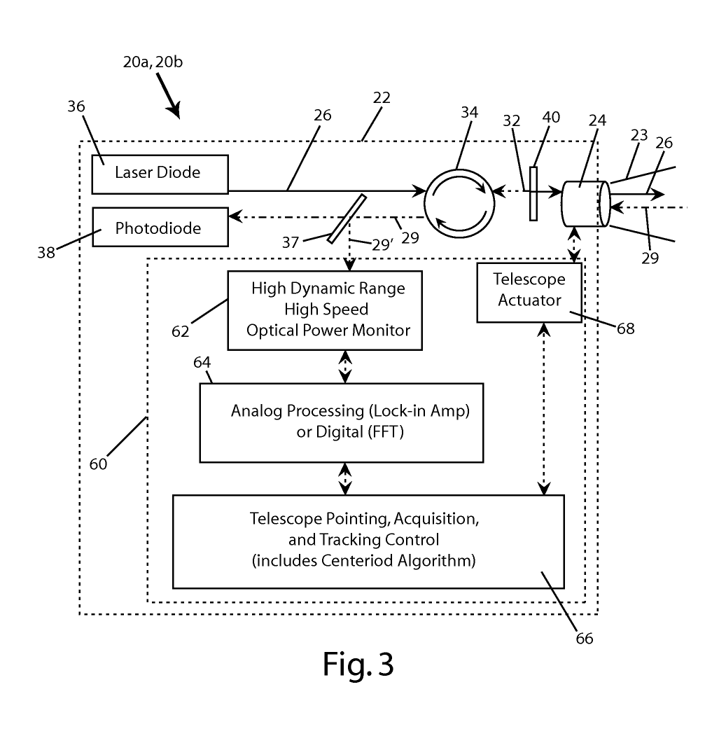

As illustrated in FIGS. 2 and 3, each telescope 24 includes one or more lenses or other optical components 25 which define the FOV 23 of the telescope. The optical components 25 focus incoming signals toward a reflective assembly 40 with the optical fiber 32 of the transceiver 20a, 20b centered therein. In the present embodiment, the reflective assembly 40 includes a mirror 30 and the receiving end of the optical fiber 32 is positioned within a through hole 31 of the mirror 30. The receiving end of the optical fiber 32 is preferably co-planar with the reflecting surface 44 of the mirror 30. While a mirror is described herein, other reflective structures may be utilized.

Each transceiver 20a, 20b is configured to transmit optical signals 26 toward the other transceiver and to receive optical signals 29 from the other transceiver 20a, 20b. The optical signal 26, 29 may be in the visible or invisible spectrum and is preferably in the form of a laser beam. In the illustrated embodiment, a laser diode 36 produces the transmit signals 26 and a photodiode 38 receives and converts the received signals 29, however, other optical components may be utilized. An optical circulator 34 is provided between the optical fiber 32 and the diodes 36, 38 to facilitate the bidirectional signal travel. Other bulk optical techniques may alternatively be used. A beam splitting mirror 37 or the like is provided along the path of the return signal 29 such that a portion 29′ of the return signal 29 is directed to the acquisition system 60. The acquisition system 60 will be described in more detail hereinafter.

Once the transmit signal 26 is aimed within the FOV of the other transceiver 20a, 20b, the signal 26 passes through the optics 25 and is focused on the mirror 30 of the reflective assembly 40. If the signal 26 is not aligned with the through hole 41, and thereby the optical fiber 32, the signal 26 will reflect off of the mirror 42 along the same path to define a retro-reflective signal 28. FIG. 1 illustrates the signal 26a within the FOV of transceiver 20b such that retro-reflective signal 28a is generated, however, signal 26b outside of the FOV of the transceiver 20a and therefore no retro-reflective signal is generated in response to signal 26b. FIG. 2 illustrates the transmit signal 26′ and retro-reflective signal 28′ furthest from the optical fiber 32 and then incrementally closer thereto at signal 26″ and signal 28″. Once the signal is precisely aligned with the optical fiber 32 as indicated at 26^{f}, the signal passes through the through hole 41 into the optical fiber 32 and no retro-reflective signal is generated.

To enhance the reliability of receipt and recognition of the retro-reflective signal 28, the acquisition system 60 is configured to identify a modulated or pulsed signal. Since optical noise, spurious optical reflections and/or other sources of glint provide a continuous (DC) signal, by looking for a modulated signal, the acquisition system 60 can identify the retro-reflective signal 28 even if it falls below the DC noise floor. That is, the acquisition system 60 will ignore continuous optical signals, for example, optical noise, spurious optical reflections and/or other sources of glint, and instead only recognize modulated signals. The illustrated acquisition system 60 includes a high dynamic range, high speed optical power monitor 62 which receives and processes the split portion 29′ of the received signal 29 to stabilize the signal. The processed signal 29′ is then directed to a phase-sensitive detector 64 which is configured to detect signals within a definite frequency band, i.e. an anticipated modulation frequency of the retro-reflective signal 28, thereby separating the modulated retro-reflective signal 28 from any optical noise, which will be outside the frequency band, which may have been included in the signal 29′. The phase-sensitive detector 64 may utilize analog processing, for example a lock-in amplifier, or digital process, for example, a fast Fourier transform device.

If a modulated retro-reflective signal 28 is identified in the detector 64, the presence of the signal 28 is communicated to a control module 66. The control module 66 is configured to control the telescope actuator 68 in response to received data to adjust the telescope 24 and steer the beam. The telescope actuator 68 may take any form, for example, a motorized gimballing system, acousto-optics, liquid crystals, electro-optics, micro-optics, a galvanometer, magnetic mirrors, micro-mirror arrays, or micro-electro-mechanical systems. The control module 66 may utilize any desired control algorithm to steer the telescope into alignment with the opposite optical fiber 32. While not shown, the acquisition system 60 may include other communication means to communicate with a central control and/or the other transceiver.

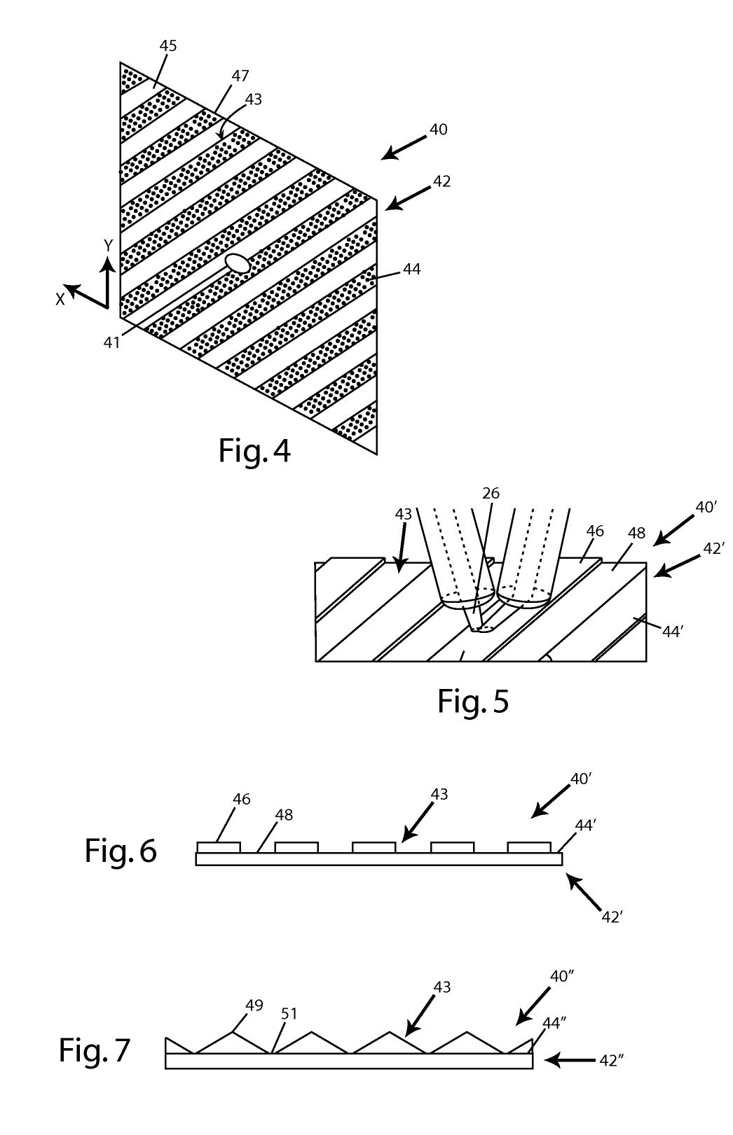

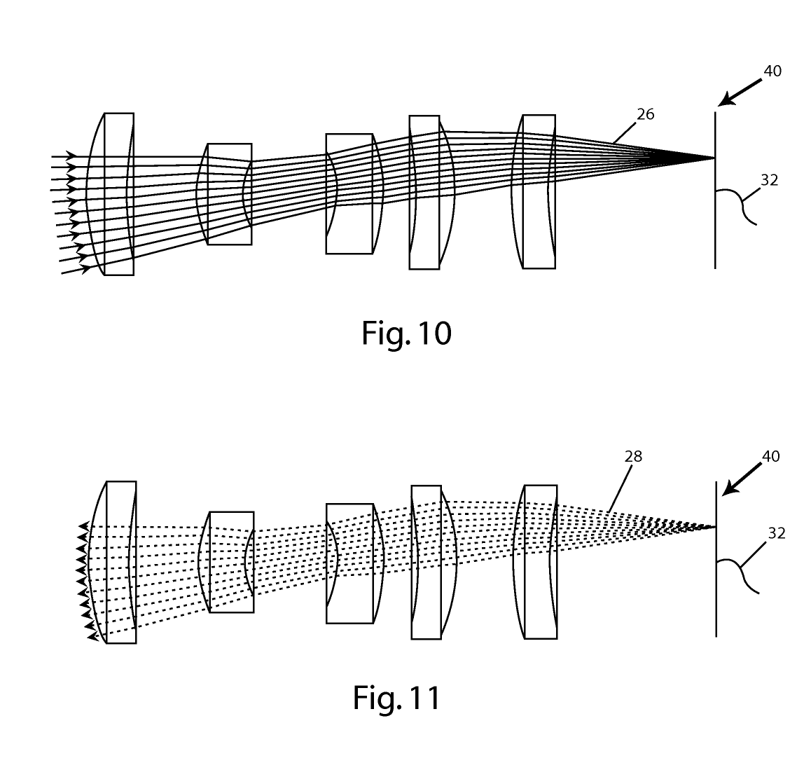

Referring to FIG. 4, a first embodiment of the reflective assembly 40 configured to generate a modulated retro-reflective signal 28 will be described. As indicated above, the reflective assembly 40 includes a mirror 42 which provides a reflective surface 44 around the through hole 41. The reflective surface 44 includes a grating 43 that modulates the retro-reflective signal 28 as the signal is translated in the X or Y direction across the surface of the mirror 42. In the embodiment described herein, the grating 43 is a reflective grating defined by transparent strips 45 alternating with opaque strips 47. When the signal 26 is directed at a transparent strip 45, the signal is reflected, but when the signal is directed at an opaque strip 47, the signal is dispersed. The strips 45, 47 preferably have a width greater than a beam diameter of the signal 26 such that a maximum contrast between the reflected portions of the signal 28 and the non-reflected portions is achieved. Additionally, the grating 43 preferably extends diagonally with respect to the X and Y directions such that the modulated signal will be produced whether the signal is translated in either the X direction or the Y direction. As shown in FIGS. 10 and 11, the transmitted continuous (DC) signal 26 is received in the opposite, receiving telescope and contacts the reflective assembly 40. As the signal 26 is translated across the grating of the mirror, a modulated retro-reflective signal 28 exits the telescope and returns to the transceiver 20 from which it came.

Referring to FIGS. 5-9, other exemplary embodiments of reflective assemblies 40′, 40″, 40′″ configured to produce a modulated retro-reflective signal 28 will be described. In the embodiment of FIGS. 5 and 6, the reflective assembly 40′ again includes a mirror 42′ with a reflective surface 44′ having a grating 43 thereon. In this embodiment, the grating 43 is a mechanical grating defined by alternating ridges 46 and grooves 48. Again, the grating 43 is preferably diagonal and the width of the ridges 46 and grooves 48 is greater than the beam diameter of the signal 26.

The embodiment illustrated in FIG. 7 is similar to the previous embodiment and includes a reflective assembly 40″ with a mirror 42″. The reflective surface 44″ again has a grating 43 thereon, however, the grating 43 is defined by alternating peaks 49 and valleys 51. Again, the grating 43 is preferably diagonal. While the peaks 49 and valleys 51 have less defined widths, such a structure may be preferred in some applications and the acquisition system 60 may be configured to recognize the modulated signal produced by such a structure. The invention is not limited to the illustrated embodiments and other reflective and mechanical gratings may be utilized.

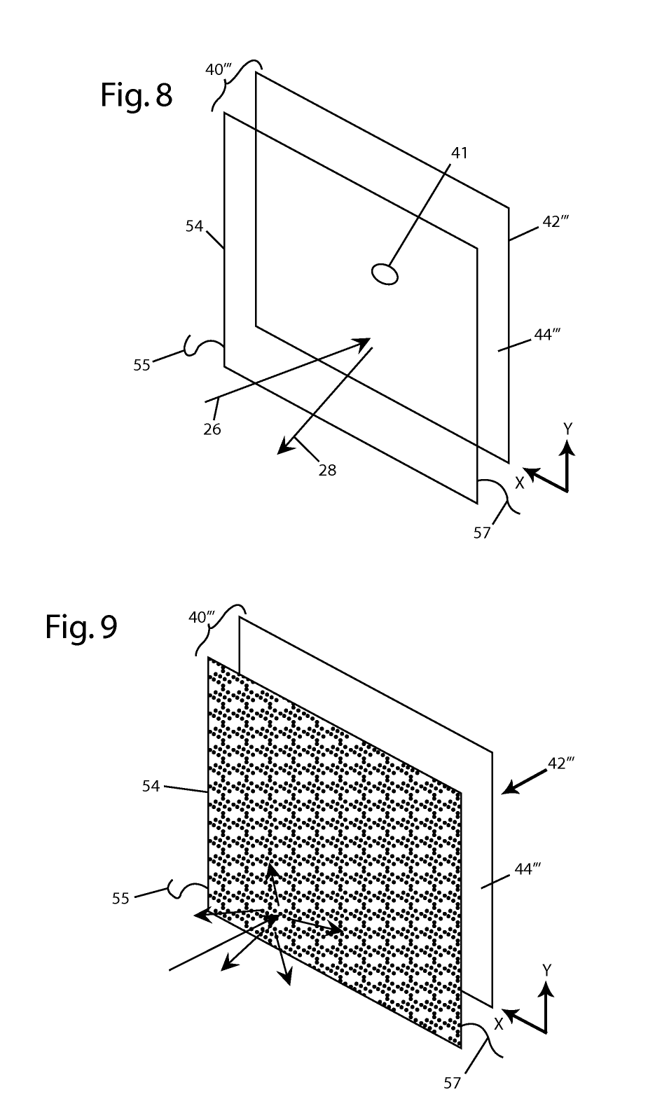

In the embodiment illustrated in FIGS. 8 and 9, the reflective assembly 40′″ includes a mirror 42′″ and a liquid crystal shutter 54. The mirror 42′″ includes a reflective surface 44′″ without any grating. A through hole 41 in the mirror 44′″ aligns with the optical fiber 32 as in the previous embodiments. The liquid crystal shutter 54 is positioned in front of the mirror 42′″ and overlies the entire reflective surface 44′″. While the liquid crystal shutter 54 is illustrated as a separate component, it may alternatively be formed integral with the mirror 42′″, e.g. as a substrate applied thereto. Power leads 55, 57 are connected to the liquid crystal shutter 54 and are configured to supply a modulated current. For example, the current may be provided by a high voltage driver and passed through a square wave generator to generate the modulated current. The acquisition system 60, or another controller, may be utilized to control the generation of the modulated current.

As shown in FIG. 8, when no current is applied to the liquid crystal shutter 54, the shutter 54 is transparent and the transmitted signal 26 passes through the shutter 54 and reflects off of the reflective surface 44′″ of the mirror 42′″ to generate a retro-reflective signal 28. However, when current is applied to the shutter 54, the shutter 54 becomes opaque and the transmitted signal is dispersed before reaching the mirror 42′″. In this way, the retro-reflective signal 28 will be modulated in correspondence to the modulation of the current applied to the shutter 58. In this embodiment, the mirror does not require a grating and the modulated signal 28 will be generated even when the signal 26 is not being translated relative to the mirror 42′″. The modulated retro-reflective signal 28 will thereafter proceed as described above with respect to the other embodiments. Once final alignment is achieved, the shutter 54 is disabled such that it does not interfere with a transmitted data signal. The shutter 54 is easily activated again if alignment is lost and the alignment procedure must be initiated. While a liquid crystal shutter is described herein, other shutters may also be utilized.

While a grated mirror and a liquid crystal shutter are described herein as the modulators, other modulators may also be utilized. For example, a mechanical beam shutter, optical chopper, liquid crystal spatial light modulator, or micro-electro-mechanical system (MEMS) may be utilized.

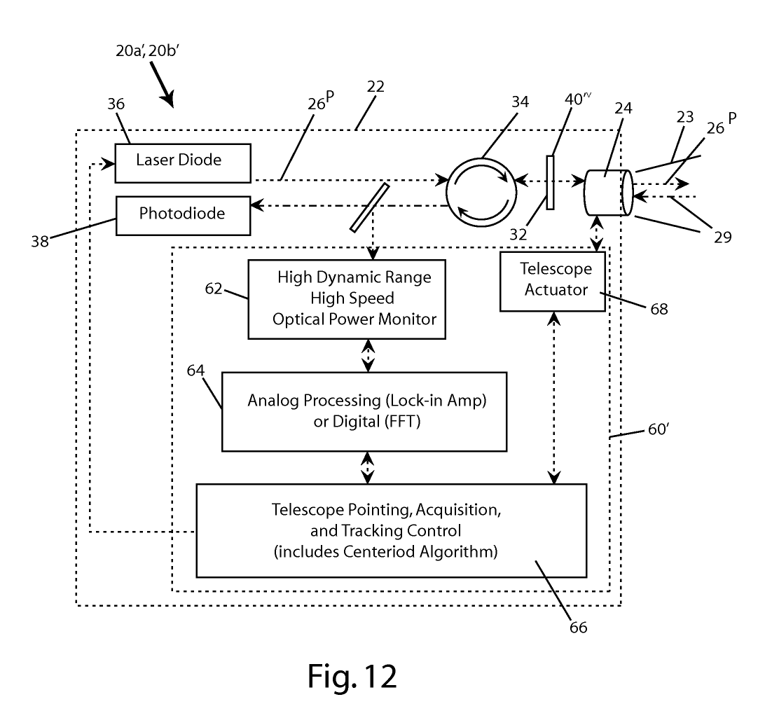

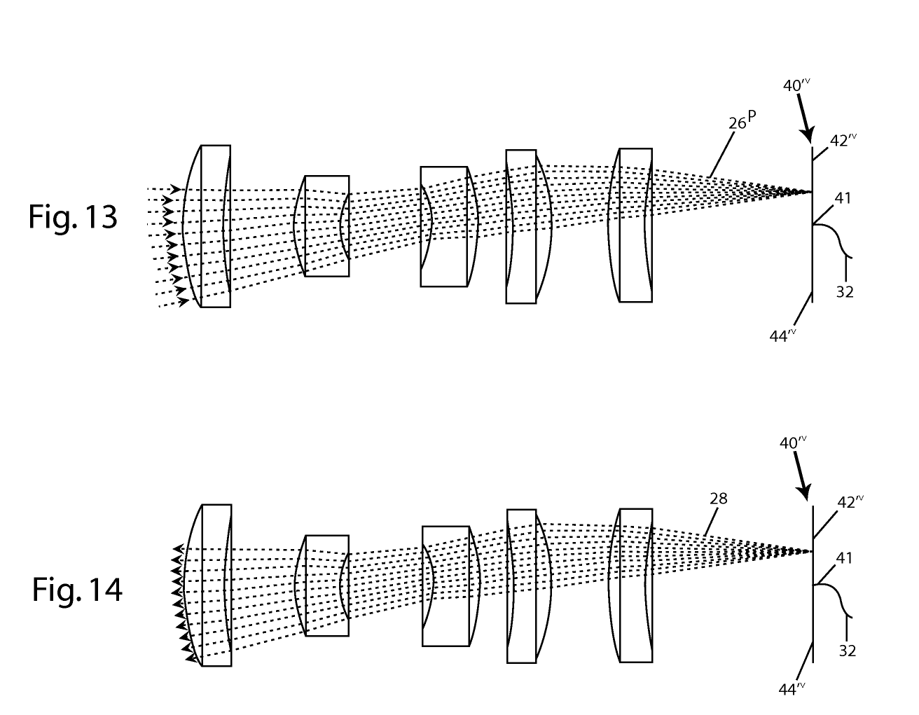

Referring to FIGS. 12-15, an alternative exemplary transceiver 20a′, 20b′ will be described. The transceiver 20a′, 20b′ is substantially the same as in the previous embodiments, however, the reflective assembly 40^{iv} is not utilized as the modulator to generate the modulated signal. Instead, the signal transmitter, in this case the laser diode 36, is used as the modulator to generate the modulated signal as will be described in more detail. As shown in FIGS. 13 and 14, the reflective assembly 40^{iv} still includes a mirror 42^{iv} with a reflective surface 44^{iv}, however, no means of modulating the signal is provided at the mirror 42^{iv}.

Referring to FIG. 12 again, the control module 66 of the acquisition system 60′ is connected to the laser diode 36 and controls the transmission of the signal therefrom. In a simplest form, the control module 66 turns the laser diode 36 on and off for predetermined periods such that the diode 36 transmits a signal 26 when on and doesn't transmit when off. In this way, the transmit signal 26^{p} is a pulsed or modulated signal as it leaves the telescope 24. The control module 66 is advantageously configured such that the laser diode 36 is on for a period less than the time of flight of the signal to the other transceiver 20a′, 20b′ such that a continuous signal does not extend between the transceivers 20a′, 20b′. Other forms of control may alternatively be utilized such that the transmitter 36 transmits a modulated signal 26P.

As shown in FIG. 13, the modulated transmit signal 26^{p} arrives at the other transceiver 20a′, 20b′ as a modulated signal. If the signal 26^{p} is not aligned with the optical fiber 32, it reflects off of the reflective surface 44^{iv} of the mirror 42^{iv} as a modulated retro-reflective signal 28. The modulated retro-reflective signal 28 will thereafter proceed as described above with respect to the other embodiments. Once final alignment is achieved, the transmitter 36 is no longer controlled to transmit a modulated signal, but instead is returned to control of the free space optical communication system 10 to transmit desired data signals. The control module 66 is easily activated again if alignment is lost and the alignment procedure must be initiated.

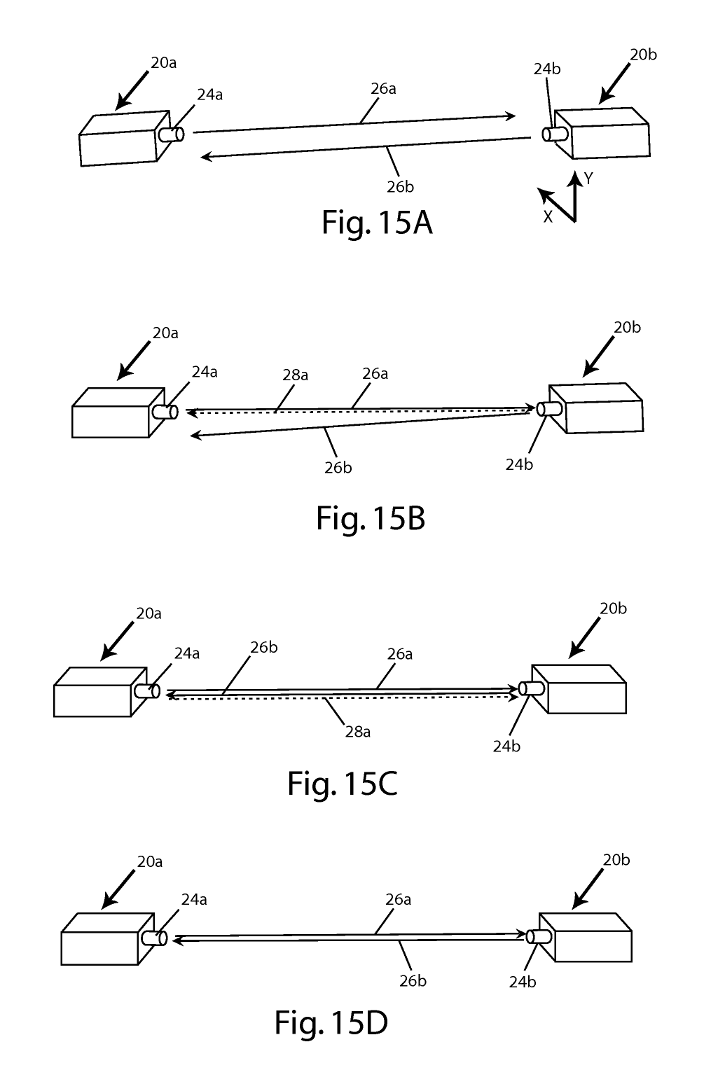

Referring to FIGS. 15A-15D, an exemplary acquisition sequence will be described. In FIG. 15A, transceiver 20a transmits a signal 26a which is not in the FOV of telescope 24b and transceiver 20b transmits a signal 26b which is not in the FOV of telescope 24a. The acquisition system 60 of each transceiver 20a, 20b adjusts the alignment of the respective telescope 24a, 24b in accordance with a macro alignment algorithm.

Referring to FIG. 15B, the signal 26a from transceiver 20a is within the FOV of telescope 24b and a modulated retro-reflective signal 28a is reflected back to telescope 24a. The retro-reflective signal 28a may be generated in any of the manners described herein. In response to receiving the modulated retro-reflective signal 28a, the acquisition system 60 of transceiver 20a begins micro adjustment of the telescope 24a. The signal 26b from transceiver 20b is still not within the FOV of telescope 24a and no retro-reflective signal is generated.

In FIG. 15C, the telescope 24a has been precisely aligned and the transmitted signal 26a is received in the optical fiber of the transceiver 20b. The telescope 24a locks into this alignment and this alignment may be utilized to macro adjust the telescope 24b such that the signal 26b is within the FOV of telescope 24a. Once within the FOV, a modulated retro-reflective signal 28b is reflected back to telescope 24b. In response to receiving the modulated retro-reflective signal 28b, the acquisition system 60 of transceiver 20b begins micro adjustment of the telescope 24b. Once telescope 24b has been precisely aligned, both telescopes 24a, 24b are fixed in alignment as shown in FIG. 15D. The free space optical communication system 10 is now ready to transmit bidirectional communications.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

What is claimed is:

1. A free space optical communication system comprising:
a first mono-static transceiver configured to transmit and receive optical signals through a first optical fiber, the first mono-static transceiver including a first reflective assembly defining a first reflective surface about a receiving end of the first optical fiber and configured to reflect optical signals within a field of view of the first transceiver but not aligned with the receiving end of the first optical fiber as a modulated retro-reflective signal;
a second mono-static transceiver configured to transmit and receive signals through a second optical fiber, the second mono-static transceiver including a second reflective assembly defining a second reflective surface about a receiving end of the second optical fiber and configured to reflect optical signals within a field of view of the second transceiver but not aligned with the receiving end of the second optical fiber as a modulated retro-reflective signal; and
each mono-static transceiver including an acquisition system configured to detect a modulated retro-reflective signal and adjust the alignment of the respective transceiver in response to a detected modulated retro-reflective signal.

2. The communication system of claim 1 wherein the first and second reflective surfaces each include a grating thereacross which causes modulation of an optical signal translated across the surface.

3. The communication system of claim 2 wherein the grating includes alternating strips of differing reflective effects.

4. The communication system of claim 2 wherein the alternating strips are positioned diagonally across the reflective surface.

5. The communication system of claim 2 wherein each of the strips has a given width which is greater than a width of the optical beam.

6. The communication system of claim 2 wherein the strips include alternating transparent and opaque strips.

7. The communication system of claim 2 wherein the strips include alternating ridges and grooves.

8. The communication system of claim 2 wherein the strips include alternating peaks and valleys.

9. The communication system of claim 1 wherein each reflective assembly includes a mirror defining the respective reflective surface and a shutter positioned in front of the reflective surface, the shutter operable between a transparent state and an opaque state to define the respective modulated retro-reflective signal.

10. The communication system of claim 1 wherein each transceiver includes a transmitter which generates an optical signal, and wherein a control module controls each transmitter to transmit a modulated signal and wherein the modulated signal reflecting off the opposed reflective surface defines the modulated retro-reflective signal.

11. The communication system of claim 1, wherein each acquisition system includes an analog or digital phase-sensitive detector.

12. A mono-static transceiver configured to transmit and receive signals through an optical fiber, the transceiver comprising:
an adjustable telescope through which optical signals are transmitting and received; and
an acquisition system configured to detect a modulated signal and adjust the alignment of the telescope in response to a detected modulated signal.

13. The transceiver of claim 12, wherein the acquisition system includes an analog or digital phase-sensitive detector.

14. The transceiver of claim 12, further comprising an optical circulator associated with the optical fiber.

15. A method of aligning a first mono-static transceiver with an optical fiber of a second mono-static transceiver, the method comprising the steps of;
transmitting an optical signal from a telescope of the first transceiver;
adjusting the alignment of the telescope of the first transceiver until the optical signal is within the field of view of the second transceiver whereby the signal is retro-reflected as a modulated signal if the signal is not aligned with the optical fiber;
receiving the modulated signal through the telescope of the first transceiver;
detecting the modulated signal with an acquisition system of the first transceiver; and
further adjusting the alignment of the telescope in response to the detected modulated signal.

16. The method of claim 15, further comprising continuing the further adjustment until the modulated signal is no longer detected.

17. The method of claim 15, further comprising conducting the original adjustment in accordance with a macro adjustment algorithm and conducting the further adjustment in accordance with a micro adjustment algorithm.

18. The method of claim 15, further comprising using an analog or digital phase-sensitive detector to detect the modulated signal.

19. The method of claim 15, further comprising generating the modulated signal with a modulator within the second transceiver.

20. The method of claim 15, further comprising transmitting the transmitted optical signal as an initial modulated signal.
